(19) United States
(12) Patent Application Publication
(10) Pub. No.: US 2022/0399147 A1
(43) Pub. Date: Dec. 15, 2022

(54) ELECTROMAGNETIC ACTUATING DEVICE

(71) Applicant: Robert Bosch GmbH, Stuttgart (DE)

(72) Inventors: Markus Stahl, Schwarzenbruck (DE); Bernhard Gnamm, Vaihingen/Enz (DE); Christof Ott, Asperg (DE); Klaus Schudt, Nordheim (DE); Ursula Luetzelberger, Tamm (DE)

(21) Appl. No.: 17/775,387

(22) PCT Filed: Sep. 21, 2020
(86) PCT No.: PCT/EP2020/076277

§ 371 Date: May 9, 2022

(30) Foreign Application Priority Data
Nov. 22, 2019 (DE) 10 2019 218 092.2

(51) Int. Cl. H01F 7/08

(52) U.S. Cl. CPC H01F 7/081; H01F 2007/086

(57) ABSTRACT

An electromagnetic actuating device includes a pole sleeve that extends along an axial direction and an armature situated radially inside the pole sleeve. The pole sleeve has a first axial end and a second axial end. The armature is guided inside the pole sleeve. The pole sleeve has, in a region situated between the axial ends, recesses whose contours each change along the axial direction.

### FIELD

The present invention relates to an electromagnetic actuating device.

### BACKGROUND INFORMATION

In passenger motor vehicle automatic transmissions, hydraulically actuated couplings are used to change gear, the hydraulic pressure at the couplings being set by hydraulic slide valves. Slide valves can be actuated via a pilot valve (pre-controlling), or can be actuated directly via an electromagnetic actuating device. In such actuating devices, in practice embodiments having a pole tube, or pole sleeve, have proven successful; i.e., the magnetic armature is guided in a pole tube. A significant emphasis of development is to achieve the highest possible level of magnetic force (large stroke work); i.e., the magnetic efficiency has to be brought to a high level. Such an actuating device having a pole tube is described in German Patent Application No. DE 10 2012 223 430 A1, in which the pole tube has a “magnetic separation” that is fashioned as a thin rotating point. The thin rotating point goes into saturation already at a low magnetic flux level, and then acts as a magnetic lock. However, the realization of the magnetic separation is associated with a certain degree of outlay during manufacturing.

### SUMMARY

An electromagnetic actuating device is provided in accordance with the present invention. Advantageous developments of the present invention are disclosed herein.

According to the present invention, an electromagnetic actuating device is provided that has a pole sleeve that extends along an axial direction and an armature situated radially inside the pole sleeve.

The pole sleeve has a first axial end and a second axial end. The armature is guided inside the pole sleeve. The pole sleeve can be made substantially cylindrical. “Substantially cylindrical” means that the pole sleeve can include collars, shoulders, grooves, changes in wall thickness, etc., but overall is fashioned in the manner of a cylinder or in the shape of a sleeve. The armature can be guided immediately or indirectly inside the pole sleeve, for example by a sliding seat. By activating the electromagnetic actuation device, for example by activating an electromagnetic coil, the armature can be displaced along its longitudinal direction in the electromagnetic actuating device. This corresponds to the classical configuration of an electromagnetic actuating device.

In accordance with an example embodiment of the present invention, in a region situated between the axial ends (plunger stage region), the pole sleeve has recesses whose contours each change along, or parallel to, the axial direction. This means that the contour of the recesses can expand or narrow along the axial direction, for example through two walls that are situated opposite one another in the recess and are angled relative to one another. The recesses can be situated in regular fashion along the circumferential direction of the pole sleeve, for example in the form of four recesses situated regularly around the circumference of the pole sleeve. The recesses can be fashioned as recesses that do not perforate through (stamped regions having reduced material thickness), or alternatively as perforations.

In accordance with the present invention, through the recesses formed in the pole sleeve, whose contours each change along the axial direction, the magnetically effective material cross-section (material volume) of the pole sleeve varies in this region (plunger stage region) along the longitudinal axis of the pole sleeve. In this way, the magnetic resistance can be modified in a targeted manner, and the magnetic force characteristic curve is correspondingly shaped thereby.

In a low-cost manner, a pole sleeve magnet can be provided having improved magnetic efficiency. Complicated manufacturing processes can be avoided, and low-cost components can be used. Through the proposed design of the pole sleeve, the magnetic efficiency can be optimized, and the magnetic flux can be predominantly transmitted by the pole sleeve itself. The armature, the pole sleeve (magnetic sleeve), and in particular also the electromagnetic coil can be configured so as to (axially) overlap one another. The electromagnetic actuating device can in particular be an electromagnetic actuating element, or an electromagnetic actuator (“electromagnet”).

The pole sleeve (magnetic sleeve) can perform one or more of the following tasks: guiding the armature in the (preferably one-part) pole sleeve, shaping the magnetic force characteristic curve via targeted changes in the material cross-section (for example recesses), in particular as a function of the armature stroke, conducting the magnetic flux into the armature, in particular radial introduction of the flux into the armature, and/or achieving a high magnetic resistance in the area of the magnetic separation, so that the magnetic flux goes into the armature. In order to provide a magnetic counter-pole to the armature pole, a cylindrical component, i.e. a pole core, can be placed into the pole sleeve.

According to a development of the present invention, the recesses, or perforations, can have a V-shaped contour, the V-shaped contour preferably tapering toward the first axial end. This provides a shaping of the magnetic force characteristic curve through a shape that is geometrically easy to produce and also easy to check.

According to a development of the present invention, the pole sleeve can have oblong openings extending in the circumferential direction, configured in a row in the circumferential direction, the recesses, or perforations, each extending along the axial direction going out from the oblong openings. In this way, in each case one oblong opening and one recess, or perforation, open into one another; i.e., the opening or the perforation extends from a side edge, facing the first axial end, of the oblong opening, along or parallel to the axial direction. In this way, on the pole sleeve a region of the magnetic separation is created, there being comparatively little material present there, in order to achieve a high magnetic resistance. In this way, a large magnetic flux is conducted into the armature. The oblong openings can each be fashioned as (not perforating) openings or, alternatively, as (perforating) oblong holes.

According to a development of the present invention, the oblong openings, or oblong holes (two oblong openings or oblong holes that are adjacent in the circumferential direction) can each be separated by one another in the circumferential direction by a web, the webs each having a reduced material thickness (relative to the material thickness of the pole sleeve in adjoining regions). This contributes to a high magnetic resistance in the area of the magnetic separation. This promotes the magnetic separation. The material thickness, for example the sheet thickness, can be reduced in the region of the webs and can optionally be stamped. The material thickness can be reduced going out from the outer circumference of the pole sleeve. This promotes a guiding of the armature inside the pole sleeve, because its inner surface can also be continued in the region of the webs.

According to a development of the present invention, the pole sleeve can be fashioned (stamped bent part) as a stamped sleeve and shaped by rolling; preferably the pole sleeve is formed at least partly by stamping. As a result, the pole sleeve is a component that can be produced at low cost, and many functions can be integrated into the pole sleeve. The production and assembly outlay are comparatively low. As a result of the rolling, the sleeve has a joint in its jacket surface (joint between the free ends; jointed sleeve). The recesses, or perforations, and/or the oblong openings or oblong holes can optionally be formed (stamped out) directly during the stamping of the pole sleeve from the initial material of the sleeve, for example sheet metal. This promotes the manufacture. The sleeve joint can extend along the axial direction of the pole sleeve (axially oriented joint).

As indicated, in the production of the pole sleeve, as an additional process stamping can optionally be provided, for example in order to form the webs reduced in their material thickness. In this way, the webs can also be produced at low cost. In addition, through stamping thinner wall thicknesses can be achieved than would be possible for example with webs produced by machining. Due to the small material cross-sections that are achievable, this promotes the magnetic separation.

According to a development of the present invention, the (for example rolled) pole sleeve can be fashioned having an open joint. This promotes the manufacture, because fastening elements and their production can be omitted. In addition, the open joint may if appropriate perform further functions, for example acting as a flow duct.

Alternatively, the pole sleeve can be bonded at the joint, in particular by latching or welding (joint ends latched or welded). This increases the stability, or shape stability, of the pole sleeve. The risk of sharp-edged projections on the inner side of the sleeve is thereby reduced. This promotes the guiding of the armature. The latching can optionally be formed directly during the stamping of the pole sleeve from its base material, for example from sheet metal. The latching can have a projection at one joint end of the pole sleeve and can have an opening at the other joint end of the pole sleeve that corresponds to the projection, in particular being complementary thereto (jigsaw puzzle-type meshing).

According to a development of the present invention, for the guidance of the armature, radially between the pole sleeve and the armature there can be situated a glass fabric film coated with PTFE (polytetrafluoroethylene). This provides a guide element for the armature, and positive sliding properties can be achieved. The glass fabric film coated with PTFE can for example be rolled to form a sleeve. The coated glass fabric film can for example be fastened on the inner circumference of the pole sleeve, for example by gluing.

According to a development of the present invention, for the guiding of the armature the pole sleeve can have on its interior circumference, and/or the armature can have on its outer circumference, a magnetically non-conductive coating, in particular a nickel layer or a nickel-phosphorus layer, the coating being made at least in some segments, and preferably being complete. In this way as well, positive sliding properties can be achieved.

According to a development of the present invention, the pole sleeve can be made of magnetically conductive steel, in particular a magnetically conductive unalloyed steel having a carbon content of less than 0.15 percent (<0.15% carbon content). In this way, an embodiment of the pole sleeve made of material having good magnetic conduction can be achieved. This contributes to advantageous magnetic properties.

According to a development of the present invention, the pole sleeve can have a material thickness (sheet thickness) of from 1 to 4 mm. In this way, a comparatively stable pole sleeve can be achieved. In addition, through such a dimensioning the magnetic flux can be transmitted at least in large part by the magnetic sleeve.

According to a development of the present invention, an electromagnetic coil can be situated radially outside the pole sleeve. This coil acts as actuating element for the armature.

According to a development of the present invention, the pole sleeve can be made in one piece. This reduces the assembly and orientation outlay, compared to a multi-part solution. In addition, through the one-part solution, the center offset of the armature to the plunger stage region, and thus the transverse forces, can be kept low.

The electromagnetic actuating device can have further components. Thus, the electromagnetic actuating device can have a housing (magnet housing) in which the components of the actuating device are housed. At an end face, in particular an end face facing the pole core, the actuating device can be closed by a terminating piece that can be a flow plate. At the opposite end face, in particular the end face facing away from the pole core, the actuating device can be closed by a cover, for example a pole plate.

For the connection of the electromagnetic actuating device, an electrical contacting can be provided that is electrically connected to the electromagnetic coil, for example a socket segment or a plug segment attached on the housing. In the pole core, there can be placed an actuating element, for example an actuating pin, that is guided through a passage made concentrically in the pole core. The actuating element can have a shaft segment and a radially expanded head segment with which it abuts the inner side of the passage on the pole core.

The armature can have a centric axial passage into which an armature bolt is pressed. The armature bolt can work together with the actuating pin, in particular with the head segment of the actuating pin. Going from radially inner to radially outer, the components can be configured as follows: armature, pole sleeve, coil, magnet housing.

The pole sleeve, preferably fashioned in one piece as a stamped bent part, can have a plurality of axial regions (in the sequence from the first axial end to the second axial end): a (first) region for conducting the magnetic flux, a plunger stage region, a region of the magnetic separation, and a (second) region for conducting the magnetic flux.

The regions for conducting the magnetic flux have as low a magnetic resistance as possible. These regions are preferably free of openings, perforations, recesses, or the like (unstructured regions). The recesses or perforations whose contour changes along the axial direction are situated in the plunger stage region. In this way, the magnetic force characteristic curve is shaped. The oblong openings or oblong holes are situated in the region of the magnetic separation. The webs reduced in their material thickness are also situated in the region of the magnetic separation. In the region of the magnetic separation there should be enough material to securely bond the regions of the pole sleeve adjoining the region of the magnetic separation, but this should be as little material as possible, in order to achieve a high magnetic resistance.

In the following, specific example embodiments of the present invention are explained with reference to the figures.

### BRIEF DESCRIPTION OF THE DRAWINGS

FIG. 1 shows a schematic section through an electromagnetic actuating device in accordance with an example embodiment of the present invention.

FIG. 2 shows the pole sleeve of the actuating device of FIG. 1, in a side view.

### DETAILED DESCRIPTION OF EXAMPLE EMBODIMENTS

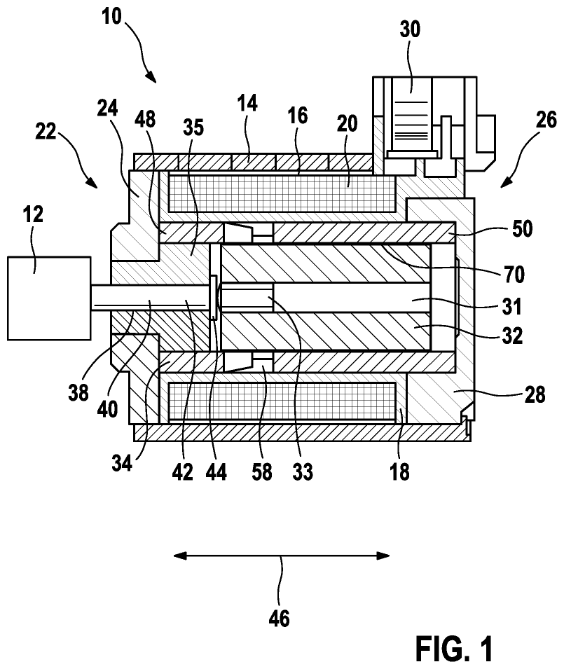

In FIG. 1, an electromagnetic actuating device is designated as a whole by reference character 10 (in the following: “actuating device 10”). Such an actuating device 10 is used for example in transmission technology in motor vehicles, in particular to control a coupling of an automatic transmission. For this purpose, for example a hydraulic valve (shown only schematically in FIG. 1 by a box provided with reference character 12) is actuated by actuating device 10.

Actuating device 10 has a housing 14 in which the components of actuating device 10 are situated. Actuating device 10 has an electromagnetic coil 16 that has a coil body 18 and a winding 20. At a first end face 22, housing 14 is closed by a terminating piece 24, for example a flow plate 24. At a second end face 26, housing 14 is closed by a cover 28, for example a pole plate 28. On housing 14, an electrical contacting 30 is provided that is electrically connected to electromagnetic coil 16.

In addition, actuating device 10 has an armature 32 (magnetic armature), a pole sleeve 34 (magnetic sleeve), and a pole core 35. Pole core 35 has a centric passage 38 through which an actuating element 40 is guided (actuating pin) that acts on hydraulic valve 12. Actuating element 40 can have a shaft segment 42 and a radially expanded head segment 44.

Armature 32 is situated radially inside pole sleeve 34. Electromagnetic coil 16 is situated radially outside pole sleeve 34. Coil 16, armature 32, and pole sleeve 34 at least partly overlap one another along axial direction 46. Pole sleeve 34 has a first axial end 48 (facing pole core 35) and a second axial end 50 (facing away from pole core 35). Armature 32 has a centric axial passage 31 and an armature bolt 33 situated therein that actuates actuating element 40.

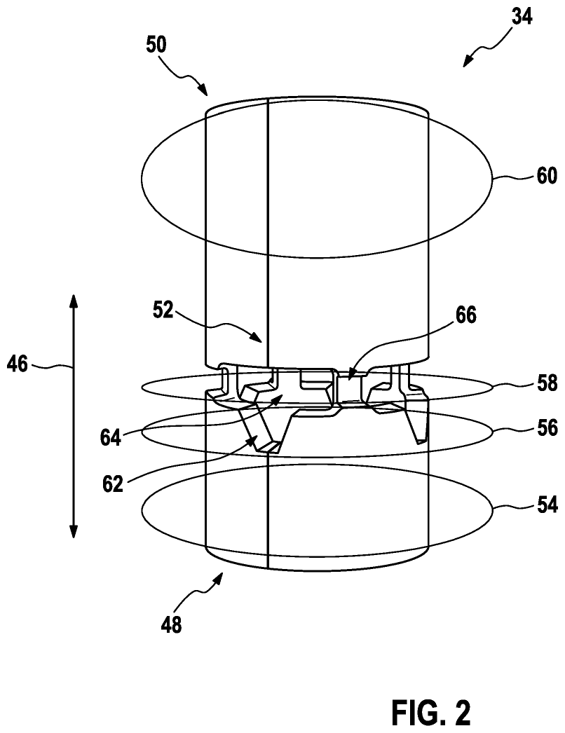

Pole sleeve 34 is fashioned as a stamped sleeve, shaped by rolling (see FIG. 2); pole sleeve 34 can also be formed partly by stamping. Pole sleeve 34 has an (axially oriented) joint 52 at which the joint ends of pole sleeve 34 abut one another.

Pole sleeve 34 has a plurality of axial regions (in the sequence from first axial end 48 to second axial end 50): a (first) region 54 for conducting the magnetic flux, a plunger stage region 56, a region 58 of the magnetic separation, and a (second) region 60 for conducting the magnetic flux (see FIG. 2).

In a region (plunger stage region 56) situated between the axial ends 48, 50, pole sleeve 34 has recesses 62 whose contours each change along axial direction 46. Recesses 62 have a V-shaped contour that narrows towards first axial end 48. Recesses 62 are distributed regularly around the circumference of pole sleeve 34; here this is illustrated as an example with four recesses 62. Recesses 62 can be fashioned for example as perforations 62 or as stamped regions having reduced material thickness.

Pole sleeve 34 has (in the region of magnetic separation 58) oblong openings 64 that extend in the circumferential direction of pole sleeve 34, and that are configured in a series in the circumferential direction, the recesses 62, each going out from the oblong openings 64, extending along axial direction 46 (toward first axial end 48). Oblong openings 64 are also distributed regularly around the circumference of pole sleeve 34, here illustrated as an example with four openings 64. Oblong openings 64 can be fashioned for example as oblong holes 64.

Oblong holes 64, i.e. two oblong holes 64 adjacent to one another in the circumferential direction, are separated from one another in each case in the circumferential direction of pole sleeve 34 by a web 66. Webs 66 each have a reduced material thickness (reduced sheet thickness). Webs 66 can be stamped.

Pole sleeve 34 can be made with an open joint 52, or can be bonded at joint 52, for example by latching or welding (not shown).

For the guiding of armature 32, a glass fabric film 70 coated with PTFE can be situated radially between pole sleeve 34 and armature 32 (bearing element for armature 32). Alternatively, pole sleeve 34 can have on its inner circumference, or armature 32 can have on its outer circumference, a magnetically non-conductive coating at least in some sections, preferably completely, in particular a nickel layer or a nickel-phosphorus layer.

Pole sleeve 34 is made of magnetically conductive steel, in particular from magnetically conductive unalloyed steel having a carbon content of less than 0.15 percent. Pole sleeve 34 has a material thickness (plate thickness) of from 1 to 4 mm. Pole sleeve 34 is made in one piece.

1-10. (canceled)

11. An electromagnetic actuating device, comprising:
a pole sleeve extending along an axial direction; and
an armature situated radially inside the pole sleeve;
wherein the pole sleeve has a first axial end and a second axial end, and the armature is guided inside the pole sleeve, and wherein the pole sleeve has, in a region situated between the axial ends, recesses whose contours each change along the axial direction.

12. The electromagnetic actuating device as recited in claim 11, wherein the recesses have a V-shaped contour, the V-shaped contour tapering toward the first axial end.

13. The electromagnetic actuating device as recited in claim 11, wherein the pole sleeve has oblong openings extending in a circumferential direction and that are configured in a series in the circumferential direction, the recesses, each extending out from the oblong openings, extending along the axial direction.

14. The electromagnetic actuating device as recited in claim 13, wherein the oblong openings are each separated from one another in the circumferential direction by a web, the webs each having a reduced material thickness.

15. The electromagnetic actuating device as recited in claim 11, wherein the pole sleeve is a sleeve that is stamped and shaped by rolling.

16. The electromagnetic actuating device as recited in claim 15, wherein the pole sleeve is formed at least partly by stamping.

17. The electromagnetic actuating device as recited in claim 11, wherein the pole sleeve is fashioned with an open joint, or the pole sleeve is bonded at the joint by latching or welding.

18. The electromagnetic actuating device as recited in claim 11, wherein for the guiding of the armature, a glass fabric film coated by PTFE is radially situated between the pole sleeve and the armature.

19. The electromagnetic actuating device as recited in claim 11, wherein for the guiding of the armature, the pole sleeve has on its inner circumference, and/or the armature has on its outer circumference, a magnetically non-conductive coating at least in some segments.

20. The electromagnetic actuating device as recited in claim 19, wherein the coating includes a nickel layer or a nickel-phosphorus layer,

21. The electromagnetic actuating device as recited in claim 11, wherein the pole sleeve is made of magnetically conductive steel.

22. The electromagnetic actuating device as recited in claim 11, wherein the pole sleeve is made of magnetically conductive unalloyed steel having a carbon content of less than 0.15 percent.

23. The electromagnetic actuating device as recited in claim 11, wherein the pole sleeve has a material thickness of from 1 to 4 millimeters, and/or an electromagnetic coil is situated radially outside the pole sleeve, and/or the pole sleeve is made in one piece.
